(19) United States
(12) Patent Application Publication
(10) Pub. No.: US 2004/0034577 A1
(43) Pub. Date: Feb. 19, 2004

(54) Methods and apparatus for analyzing an inventory for consolidation

(76) Inventors: Jeffrey N. Van Hoose, Fairview Heights, IL (US); Mark A. Freestone, Cincinnati, OH (US); Rohit Gupta, Mason, OH (US)

Correspondence Address: BUCKLEY, MASCHOFF, TALWALKAR LLC, 5 ELM STREET, NEW CANAAN, CT, 06840, US

(21) Appl. No.: 10/219,429

(22) Filed: Aug. 15, 2002

(51) Int. Cl. G06F 17/60

(52) U.S. Cl. 705/28

(57) ABSTRACT

A system, method, apparatus, means, and computer program code for evaluating potential changes to a computer or communications system. For example, an analysis may involve the partial or total consolidation of one or more servers in a computer system. The analysis may start by determining an inventory of the computer system to determine “like” elements and determining potential scenarios that use different combinations of the like elements. From these scenarios, different possible configurations that consolidate some or all of two or more of servers in the system are determined and financial models or other information determined for the different configurations. The different configurations can then be ranked or reported in accordance with one or more designated factors or other criteria.

### FIELD OF THE INVENTION

The present invention relates to a method and apparatus for analyzing an inventory and, more particularly, embodiments of the present invention relate to methods, means, apparatus, and computer program code for analyzing potential consolidations to elements in an inventory of a computer or communications system or network.

### BACKGROUND OF THE INVENTION

Given rapid technical advancements for hardware and software and growth in user and application growth for resources connected to networks, it is common for computer and communication systems to grow, require upgrades or new equipment, develop new requirements, etc. over time. In a complex computer or communication system, determining the best way to consolidate or migrate a computer or communication system is difficult to determine. In addition, different technical solutions may create different financial results and so both financial and technical factors should be taken into account when determining a change or migration of a computer or communications system.

Unfortunately, tools do not exist that permit an in-depth financial and technical analysis of potential migrations or consolidations of a computer or communications system. It would be advantageous to provide a method and apparatus that overcame the drawbacks of the prior art. In particular, it would be desirable to provide a system, methods, apparatus, means and computer code that allowed detailed analysis of an existing computer or communications system to evaluate potential changes to the computer or communications system.

### SUMMARY OF THE INVENTION

Embodiments of the present invention provide a system, method, apparatus, means, and computer program code for evaluating potential changes to a computer or communications system. In some embodiments, different types of analysis may occur. For example, an analysis may involve the partial or total consolidation of one or more servers in a computer system. The analysis may start by determining an inventory of the computer system to determine “like” elements and determining potential scenarios that use different combinations of the like elements. From these scenarios, different possible configurations that consolidate some or all of two or more of servers in the system are determined and financial models or other information determined for the different configurations. The different configurations can then be ranked or reported in accordance with one or more designated factors or other criteria.

Additional objects, advantages, and novel features of the invention shall be set forth in part in the description that follows, and in part will become apparent to those skilled in the art upon examination of the following or may be learned by the practice of the invention.

According to embodiments of the present invention, a method for facilitating consolation of an inventory of elements may include determining a plurality of sets of like elements from an inventory of elements; determining, for at least one of the plurality of sets of like elements, a plurality of potential scenarios, wherein each of the plurality of potential scenarios includes at least two of the like elements; determining, for at least one of the plurality of potential scenarios, a plurality of potential configurations, wherein each of the plurality of potential configurations represents a consolidation of at least two of the like elements; and providing information regarding at least one of the plurality of potential configurations. In some other embodiments, a method for facilitating analysis of an inventory of elements for consolidation may include determining an inventory of elements; determining a plurality of sets of like elements from the inventory of elements; determining, for at least one of the plurality of sets of like elements, a plurality of potential scenarios, wherein each of the plurality of potential scenarios includes at least to of the like elements; determining, for at least one of the plurality of potential scenarios, a plurality of potential configurations, wherein each of the plurality of potential configurations represents a consolidation of at least two of the like elements; and conducting a financial analysis of at least one of the plurality of potential configurations. In some additional embodiments, a method for facilitating analysis of an inventory of elements may include determining an inventory of elements; determining a plurality of sets of like elements from the inventory of elements; determining, for each of the set of like elements in the plurality of sets of like elements, a plurality of potential scenarios, wherein each of the plurality of potential scenarios includes at least to of the like elements; determining, for each scenario in the plurality of potential scenarios, a plurality of potential configurations, wherein each of the plurality of potential configurations represents a consolidation of at least two of the like elements; and conducting a financial analysis of each of the plurality of potential configurations.

According to embodiments of the present invention, a system for facilitating analysis of an inventory of elements may include a memory; a communication port; and a processor connected to the memory and the communication port, the processor being operative to determine a plurality of sets of like elements from an inventory of elements; determine, for at least one of the plurality of sets of like elements, a plurality of potential scenarios, wherein each of the plurality of potential scenarios includes at least two of the like elements; determine, for at least one of the plurality of potential scenarios, a plurality of potential configurations, wherein each of the plurality of potential configurations represents a consolidation of at least two of the like elements; and provide information regarding at least one of the plurality of potential configurations. In some other embodiments, a system for facilitating analysis of an inventory of elements may include a memory; a communication port; and a processor connected to the memory and the communication port, the processor being operative to determine an inventory of elements; determine a plurality of sets of like elements from the inventory of elements; determine, for at least one of the plurality of sets of like elements, a plurality of potential scenarios, wherein each of the plurality of potential scenarios includes at least to of the like elements; determine, for at least one of the plurality of potential scenarios, a plurality of potential configurations, wherein each of the plurality of potential configurations represents a consolidation of at least two of the like elements; and conduct a financial analysis of at least one of the plurality of potential configurations. In some addition embodiments, a system for facilitating analysis of an inventory of elements may include a memory; a communication port; and a processor connected to the memory and the communication port, the processor being operative to determine an inventory of elements; determine a plurality of sets of like elements from the inventory of elements; determine, for each of the set of like elements in the plurality of sets of like elements, a plurality of potential scenarios, wherein each of the plurality of potential scenarios includes at least to of the like elements; determining, for each scenario in the plurality of potential scenarios, a plurality of potential configurations, wherein each of the plurality of potential configurations represents a consolidation of at least two of the like elements; and conduct a financial analysis of each of the plurality of potential configurations.

According to embodiments of the present invention, a computer program product in a computer readable medium for facilitating analysis of an inventory of elements may include first instructions for identifying a plurality of sets of like elements from an inventory of elements; second instructions for identifying, for at least one of the plurality of sets of like elements, a plurality of potential scenarios, wherein each of the plurality of potential scenarios includes at least two of the like elements; third instructions for identifying, for at least one of the plurality of potential scenarios, a plurality of potential configurations, wherein each of the plurality of potential configurations represents a consolidation of at least two of the like elements; and fourth instructions for sending information regarding at least one of the plurality of potential configurations. In some other embodiments, a computer program product in a computer readable medium for facilitating analysis of an inventory of elements may include first instructions for identifying an inventory of elements; second instructions for identifying a plurality of sets of like elements from the inventory of elements; third instructions for identifying, for at least one of the plurality of sets of like elements, a plurality of potential scenarios, wherein each of the plurality of potential scenarios includes at least to of the like elements; fourth instructions for identifying, for at least one of the plurality of potential scenarios, a plurality of potential configurations, wherein each of the plurality of potential configurations represents a consolidation of at least two of the like elements; and fifth instructions for determining a financial analysis of at least one of the plurality of potential configurations. In some additional embodiments, a computer program product in a computer readable medium for facilitating analysis of an inventory of elements may include first instructions for identifying an inventory of elements; second instructions for identifying a plurality of sets of like elements from the inventory of elements; third instructions for identifying, for each of the set of like elements in the plurality of sets of like elements, a plurality of potential scenarios, wherein each of the plurality of potential scenarios includes at least to of the like elements; fourth instructions for identifying, for each scenario in the plurality of potential scenarios, a plurality of potential configurations, wherein each of the plurality of potential configurations represents a consolidation of at least two of the like elements; and fifth instructions for determining a financial analysis of each of the plurality of potential configurations.

According to embodiments of the present invention, an apparatus for consolidation may include means for identifying a plurality of sets of like elements from an inventory of elements; means for identifying, for at least one of the plurality of sets of like elements, a plurality of potential scenarios, wherein each of the plurality of potential scenarios includes at least two of the like elements; means for identifying, for at least one of the plurality of potential scenarios, a plurality of potential configurations, wherein each of the plurality of potential configurations represents a consolidation of at least two of the like elements; and means for sending information regarding at least one of the plurality of potential configurations. In some other embodiments, an apparatus for facilitating analysis of an inventory of elements may include means for identifying an inventory of elements; means for identifying a plurality of sets of like elements from the inventory of elements; means for identifying, for at least one of the plurality of sets of like elements, a plurality of potential scenarios, wherein each of the plurality of potential scenarios includes at least to of the like elements; means for identifying, for at least one of the plurality of potential scenarios, a plurality of potential configurations, wherein each of the plurality of potential configurations represents a consolidation of at least two of the like elements; and means for determining a financial analysis of at least one of the plurality of potential configurations. In some additional embodiments, an apparatus for facilitating analysis of an inventory of elements may include means for identifying an inventory of elements; means for identifying a plurality of sets of like elements from the inventory of elements; means for identifying, for each of the set of like elements in the plurality of sets of like elements, a plurality of potential scenarios, wherein each of the plurality of potential scenarios includes at least to of the like elements; means for identifying, for each scenario in the plurality of potential scenarios, a plurality of potential configurations, wherein each of the plurality of potential configurations represents a consolidation of at least two of the like elements; and means for determining a financial analysis of each of the plurality of potential configurations.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

FIG. 1 is a block diagram of system components for an embodiment of an apparatus usable with the methods of the present invention;

FIG. 2 is a flowchart of a first embodiment of a method in accordance with the present invention;

FIG. 3 is a table showing a representative inventory that may result from the determine inventory step of FIG. 2;

FIG. 4 is a table showing representative information regarding the servers listed in the inventory table of FIG. 3;

FIG. 5 is a flowchart further describing the conduct analysis step of FIG. 2;

FIG. 6 is a table showing representative operating systems and operating system families for a collection of servers;

FIG. 7 is a table showing representative groupings of like elements based on the table of FIG. 6;

FIG. 8 is a table showing representative scenarios generated from the table of FIG. 7;

FIG. 9 is a table showing potential systems that may support a scenario being analyzed in accordance with the method of FIG. 5;

FIG. 10 is a table showing components used in one of the scenarios of FIG. 8; and.

FIG. 11 is a block diagram of components for an embodiment of a server of FIG. 1;

FIG. 12 is an illustration of a representative interface that may be used in some embodiments of the present invention;

FIG. 13 is another illustration of a representative interface that may be used in some embodiments of the present invention;

FIG. 14 is another illustration of a representative interface that may be used in some embodiments of the present invention;

FIG. 15 is another illustration of a representative interface that may be used in some embodiments of the present invention; and

FIG. 16 is another illustration of a representative interface that may be used in some embodiments of the present invention.

### DETAILED DESCRIPTION

Applicants have recognized that there is a market opportunity for systems, means and methods that allow of facilitate the evaluation or analysis of a designated infrastructure or system and the development and analysis of alternative configuration scenarios. For example, the results of an evaluation of a company's network configuration might indicate potential savings resulting from a partial or full server consolidation. The methods and apparatus of the present invention allow analysis for many different kinds of consolidations or reconfigurations including, but not limited to, total, partial or system consolidation of servers; reconfiguration of telephony systems; reconfiguration or consolidation of a storage area network. These and other features will be discussed in further detail below, by describing a system, individual devices, and processes according to embodiments of the invention.

System

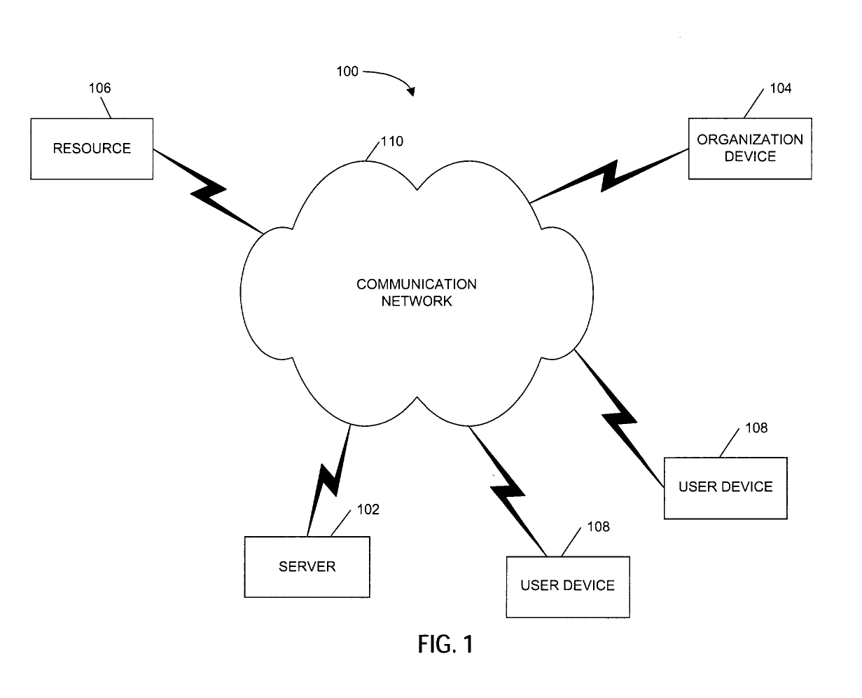

Now referring to FIG. 1, an apparatus or system 100 usable with the methods disclosed herein is illustrated. The apparatus 100 may include one or more servers, controllers or other devices 102 that communicate directly or indirectly with one or more organization devices 104, resources (e.g., database server) 106 and/or user devices via a computer, data, or communications network 110

In some embodiments, the server 102 can comprise a single device or computer, a networked set or group of devices or computers, a workstation, etc. In some embodiments, a server 102 also may function as a database server and/or as a web site hosting device. The use, configuration and operation of the server 102 will be discussed in more detail below.

The user or client devices 108 preferably allow entities to interact with the server 102 and the remainder of the apparatus 100. The user devices 108 also may enable a user to access Web sites, software, databases, etc. hosted or operated by the servers 102. If desired, the user devices 108 also may be connected to or otherwise in communication with other devices. Possible user devices include a personal computer, portable computer, mobile or fixed user station, workstation, network terminal or server, cellular telephone, kiosk, dumb terminal, personal digital assistant, etc. In some embodiments, information regarding one or more users and/or one or more user devices may be stored in, or accessed from, a user information database and/or a user device information database.

The organization device 104 may be a form of user device 108 or be similar to the server 102. A organization device 104, or a person using the organization device 104, may allow access to the server 102 for implementation of the methods of the present invention, as will be discussed in more detail below.

The resource 106 may be or include a database, expert system, knowledgebase, log, etc. that contains information usable by the server 102 to implement the methods of the present invention, as will be discussed in more detail below. For example, the resource 106 may be used to store hardware and/or software information for potential configurations of equipment or devices that may be evaluated by the server 102. In some embodiments, the resource may be part of the server 102.

Many different types of implementations or hardware configurations can be used in the system 100 and with the methods disclosed herein and the methods disclosed herein are not limited to any specific hardware configuration for the system 200 or any of its components.

The communications network 110 might be or include the Internet, the World Wide Web, or some other public or private computer, cable, telephone, client/server, peer-to-peer, or communications network or intranet, as will be described in further detail below. The communications network 110 illustrated in FIG. 1 is meant only to be generally representative of cable, computer, telephone, peer-to-peer or other communication networks for purposes of elaboration and explanation of the present invention and other devices, networks, etc. may be connected to or form part of the communications network 110 without departing from the scope of the present invention. The communications network 110 also can include other public and/or private wide area networks, local area networks, wireless networks, data communication-networks or connections, intranets, routers, satellite links, microwave links, cellular or telephone networks, radio links, fiber optic transmission lines, ISDN lines, T1 lines, DSL, etc. In some embodiments, a user device 108 may be connected directly to the server 102 without departing from the scope of the present invention. Moreover, as used herein, communications include those enabled by wired or wireless technology.

The devices shown in FIG. 1 need not be in constant communication. For example, a user device 108 may communicate with a server 102 only when such communication is appropriate or necessary.

In some embodiments, the server 102 may implement one or more of the methods described herein. More specifically, a user wanting to conduct an analysis of a computer or communication system may access the server 102 from a user device 108. The server may provide interfaces, a Web site, or software that allows the user to provide information regarding the computer or communication system to be analyzed, the type of analysis the user wishes to conduct, etc. In some embodiments, the interface may be provided via a browser or other software operating on a user device 108 or via a Web site.

Upon conducting the analysis, the server 102 may provide reports or other results of the analysis via the interfaces, Web site or other software. Alternatively, the server 102 may provide the reports or other results in or as part of an electronic communication or transmission (e.g., email message, instant message, XML or FTP transmission).

Process Description

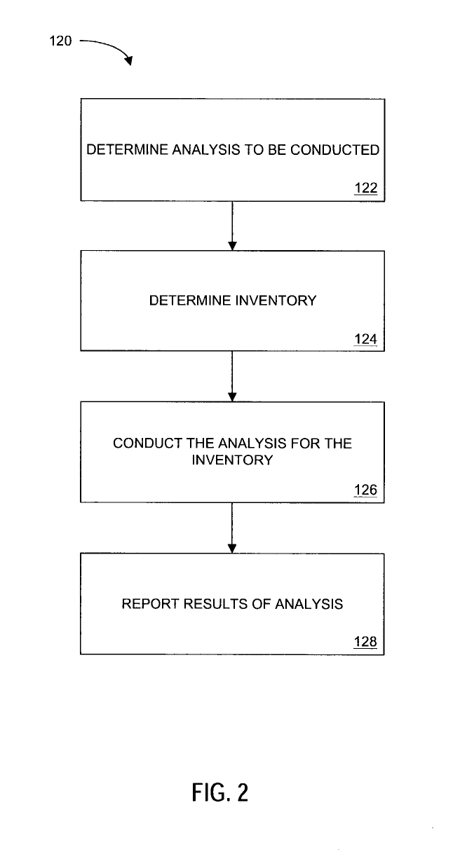

Reference is now made to FIG. 2, where a flow chart 120 is shown which represents the operation of a first embodiment of the present invention. The particular arrangement of elements in the flow chart 120 is not meant to imply a fixed order to the steps; embodiments of the present invention can be practiced in any order that is practicable. In some embodiments, some or all of the steps of the method 120 may be performed or completed by the server 102 or by a user device 108, as will be discussed in more detail below.

Processing begins at a step 122 during which an analysis to be conducted is determined. For example, in some embodiments, analysis of potential options for a total, partial or system level consolidation of multiple servers may be desired.

In general, in a total server consolidation, each server being consolidated in a scenario preferably is identical. In more practical terms, this means that each server preferably has the same application software loads (or be able to support the same loads), the same operating system loads (or, as before, be upgradeable to the same loads), and the same hardware architecture as the other servers. Typically, in a total server consolidation, applications loaded on to the servers in a particular configuration are consolidated into a single operating system image running a single instance of the application software.

In general, in a partial server consolidation, servers in a scenario preferably are running the same operating system loads, and the same hardware architecture, but the applications operating on the servers may be different. In this model, multiple applications are “merged” into a single instance of the operating system, but the different applications are retained as independent processes running on the operating system. For example, in a total server consolidation, five Oracle™ 8.1.7 servers may be consolidated into a single server running a single instance of the Oracle™ software. In a partial server consolidation, the same five servers can be consolidated into a single server, but there may be five separate instances of the Oracle™ software operating on the server as opposed to a single instance.

In general, in a box or system consolidation, the different servers in a scenario are merged into a single unifying box, but each server in the consolidation retains its same operating system load and its same application load. In this model, for example, the five Oracle™ servers used in the above example would still be running five different instances of the operating system, and would have five different instances of the operating system. Only the hardware is shared. This functionality may only be supported on certain hardware platforms and certain levels of hardware. For example, on Sun Microsystems's Enterprise™ 10000 and 15000 platforms, and on some technology from the IBM Corporation.

As another example of a type of analysis, analysis of potential options for an IP (internet protocol) telephony upgrade may be desired. In a typical IP telephony upgrade analysis, a customer's phone configuration may be analyzed and matching against or compared to one or more equivalent IP telephony systems. In many implementations of an IP telephony upgrade analysis of a customer, the customer may have only a single telephone system at a single location, so there may not be different hardware/software configurations to analyze. Instead, the analysis may look at different features (e.g.,,caller ID, voice mail, conference calling) provided to or at different aspects of the customer's telephone system.

As another example of a type of analysis, analysis of potential options for a storage consolidation may be desired. In a typical storage consolidation analysis, combinatorial groups of servers may be taken and the ability to move their storage into a SAN (storage area network) environment analyzed. In order to provide this capability, there may be requirements, such as, for example: (i) adequate storage; (ii) sufficient performance for that storage; (iii) adequate and sufficient SAN capacity between the servers in the scenario and the storage; and (iv) the storage must support any required feature sets (e.g., RAID-5, mirroring, etc.). Similar to a server consolidation analysis, the storage consolidation analysis may take various servers in a configuration, build different combinations of systems, and find the configuration that will (if possible) support any designated requirements.

There are many ways in which the step 122 may be implemented or conducted. For example, in some embodiments, a person using the user device 108 may access the server 102. The server 102 may provide a Web page or other interface or dashboard that may allow the person to select from a menu which type of analysis the person desires to conduct. As another example, software operating on the user device 108 may allow the user to select or indicate a type of analysis to be conducted.

In some embodiments of the method 120, the step 122 may not be needed and may be considered optional. For example, in some embodiments client or server based software implementing the method 100 may allow only one type of analysis (e.g., total server consolidation) to be conducted. Thus, the step 122 may not be needed in such a situation.

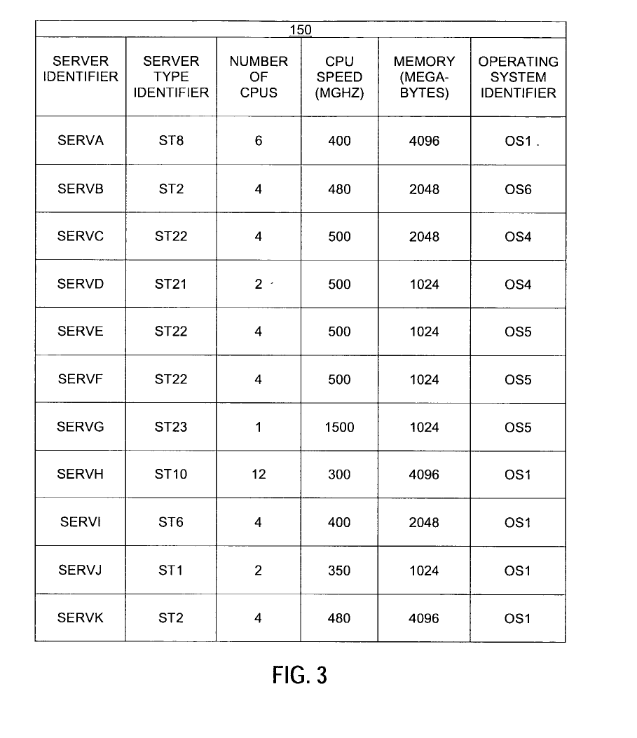

During a step 124, an inventory is determined for the analysis determined during the step 122. For example, if a server consolidation is to be conducted for a given infrastructure or scenario, determining an inventory may include obtaining information regarding the hardware and software configurations for all of the servers in the scenario. For example, now referring to FIG. 3, a table 150 provides a representative inventory that may be determined during the step 124. The results of the inventory include eight servers identified as SERVA, SERVB, SERVC, SERVD, SERVE, SERVF, SERVG, SERVH, SERVI, SERVJ, and SERVK, each of which has an associated server type identifier, current number of central processing units (CPUs), memory in megabytes, and an identifier associated with an installed operating system. Each of the CPUs operating on a server also may have an associated CPU speed. In some embodiments, the inventory table 150 may be stored in a database. Alternatively, in some embodiments, the server 102 or other device conducting the step 124 may receive or access a file, record or table that contains the inventory information. In some embodiments, the step 124 may occur prior to the step 122.

The table 150 may be provided via or as part of an interface that allows a user to enter inventory information. For example, the server 102 may operate a Web site that allows a user to populate or otherwise provide the information in the table 150. As another example, software operating on a user device 108 may allow the user to enter or provide information for the inventory. In some embodiments, an interface may prompt or query a user to provide the inventory information. In addition, an interface may request additional information regarding some or all of the equipment information entered by a user. For example, the interface may request, or prompt the user to provide, information regarding location of pieces of equipment, details regarding connections or bandwidth requirements or capabilities between pieces of equipment, information regarding applications and other software operating on pieces of equipment, the purchase or lease date and price of pieces of equipment, the maintenance and support costs, fees or requirements associated with pieces of equipment, feature sets provided by pieces of equipment, vendors of pieces of equipment, etc. In some embodiments, servers or other equipment may be consolidated only if they are in the same location.

As illustrated in the table 150, the server identified as SERVA has an associated server type ST8, six CPUs (each of which operates at four hundred megahertz), 4,096 megabytes of memory, and is using the operating system having the operating system identifier “OS1”.

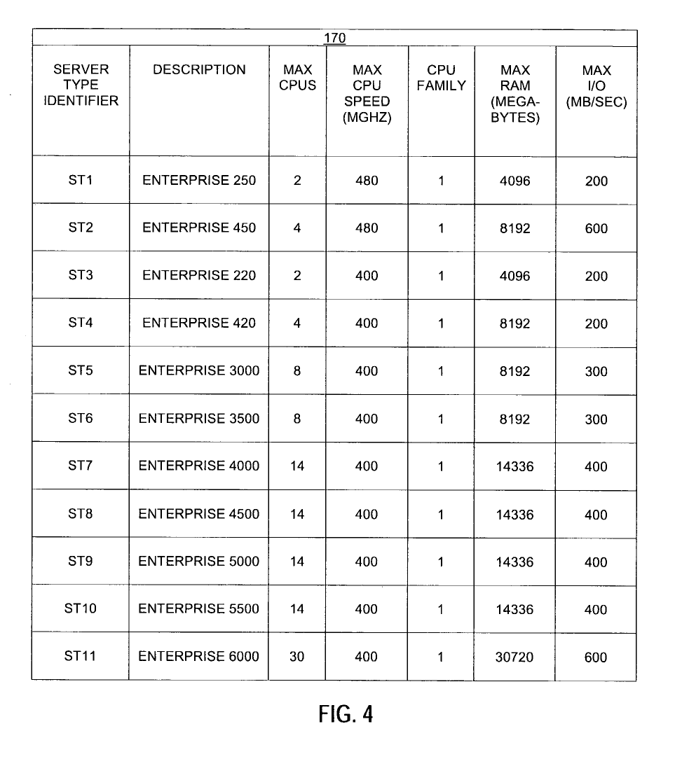

A server type identifier for a server may be an indication of the model, manufacturer, etc. of the server. An operating system identifier may be an indication of the particular operating system (e.g., Windows NT™ operating system) currently operating on the server. In some embodiments, information regarding server types and operating systems may be stored in a knowledgebase or other resource (e.g., the resource 106) for use during the method 120. For example, now referring to FIG. 4, a table 170 is illustrated that may be used in a knowledgebase to maintain information regarding server types. Note that for purposes of brevity in the table 170, not all of the server types used in the table 150 are described in the table 170. As illustrated in the table 170, a server type may have or support an associated description, a maximum number of CPUs (each having a maximum CPU speed in megahertz) that can be installed, an associated CPU family, a maximum amount of RAM in megabytes that can be used, and a maximum I/0 of bandwidth in megahertz. A CPU family is a class of processor whose members are compatible with each other. For example, in the Pentium III™ processor line from the Intel Corporation, there were a number of different revisions and versions, but all were essentially the same processor. These different revisions and versions of the processor line would be considered a single CPU family. On the other hand, an Intel Pentium IV™ processor has different characteristics than an Intel Pentium III™ processor, and so it would be a separate family. In some embodiments, an interface provided or displayed to a user may allow the user to access, view, or enter information into the table 170 or a similar table.

In some embodiments, a knowledgebase or other information resource may store information regarding operating systems in a similar manner to the table 170. For example, information stored in the knowledgebase regarding operating systems may include what versions of the operating system are available, and an interoperability matrix describing which versions of the operating system can be upgraded from and to.

As another example, if an IP telephony upgrade is to be conducted for a given infrastructure or scenario, determining an inventory may include obtaining information regarding the number and locations of telephones or handsets in the scenario, the features provided for or at each of the telephones, the lease or purchase date of the telephones, the lease or purchase prices of the telephones, the number of trunk lines and tie lines, number of voice mail ports, conferencing features, etc. A Web site or other software interface may be used to allow a user to enter or provide information regarding the inventory information for the IP telephony upgrade. Alternatively, the server 102 or other device conducting the step 124 may receive, retrieve or access a file or record that contains the inventory information.

As another example, if a storage consolidation is to be conducted for a given infrastructure or scenario, determining an inventory may include obtaining information regarding storage provided by different servers, performance requirements of capabilities for storage provided by different servers, feature sets provided by different servers, RAID levels that may be available, replication, backup features, disaster recovery capabilities, etc. A Web site or other software interface may be used to allow a user to enter or provide information regarding the inventory information for the storage consolidation. Alternatively, the server 102 or other device conducting the step 124 may receive, retrieve or access a file or record that contains the inventory information.

There are many ways in which the step 124 may be implemented or conducted. For example, in some embodiments, a person using the user device 108 may access the server 102. The server 102 may provide a web page or other interface or dashboard that may allow the person to enter or provide information regarding an inventory for a scenario. Alternatively, the server 102 may receive in a communication (e.g., email, FTP transmission, XML transmission) or retrieve the inventory information from a user device 108, the organization device 104, or some other device or database. As another example, software operating on the user device 108 may allow the user to enter inventory information. The user device 108 may conduct the remainder of the method 120 or provide the inventory information to another device (e.g., the server 102) so that the other device can conduct the remainder of the method 120.

During a step 126, the analysis determined during the step 126 is conducted with regard to the inventory determined during the step 124. Potential implementations of the step 126 will be discussed in more detail below.

During a step 128, the results of the analysis conducted during the step 126 is reported or otherwise provided. For example, results of the analysis may be provided via a Web site or interface, emailed or otherwise transmitted to one or more parties or devices, stored in a database, etc. As another example, a Web site or interface may allow a user to select or view one or more reports resulting from an analysis of an inventory. In some embodiments, results or reports regarding an analysis may include configuration diagrams showing the proposed configuration, ROI (return on investment) cost worksheets with the various costs involved broken out month by month, and utilization graphs showing the utilizations of various aspects of each individual member of the analysis.

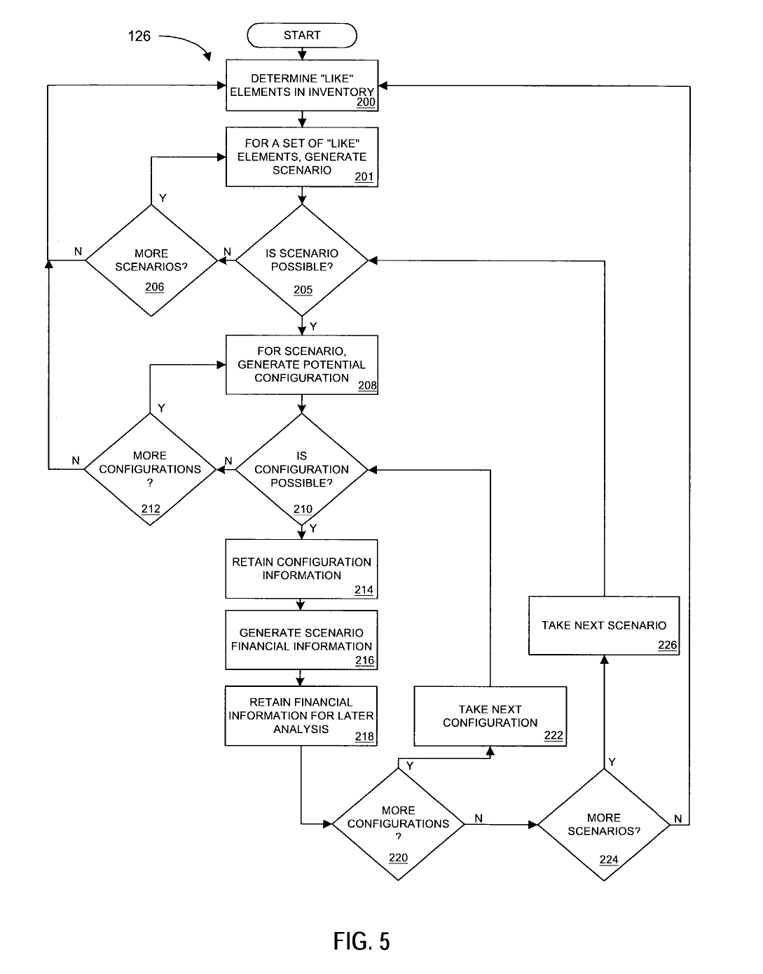

Reference is now made to FIG. 5, where a flow chart is shown which represents a potential operation of the step 126 of the method 100. For purposes of discussion, but not limitation, the steps illustrated in FIG. 5 will be assumed to be conducted by the server 102.

Processing begins at a step 200 during which “like” elements are determined for the inventory determined during the step 124. In some embodiments, the method 100, the step 126 or the step 200 may include defining or determining what constitutes “like” elements in regard to the analysis determined during the step 122.

The definition of what constitutes a like element may vary for different analyses that may be conducted for a given inventory. For example, in a total server consolidation, like elements may be considered to as servers that have the same or similar “hardware architecture”, the same operating system version (or are able to upgraded to the appropriate operating system version), and the same installed applications and versions (or are able to upgrade to the appropriate applications and their versions). In some embodiments of a total server consolidation, two servers may be considered “like” if they have the same operating system family even if they have different operating systems, as will be discussed in more detail below.

In a partial server consolidation, like elements are servers that have the same hardware architecture and the same operating system version (or be able to upgrade to the appropriate operating system version). Thus, unlike in a total server consolidation, the applications and versions operating on different servers may be different, even though the servers are considered “like” for purposes of the partial server consolidation. In a system or box consolidation, like elements are servers that have the same hardware architecture although operating system versions and applications may be different.

As another example of like elements, in an IP telephony upgrade analysis, two elements may be considered to be “like” if they provide (at a minimum) the same level of services and capabilities that are currently in place or unlike if they do not.

In a storage consolidation analysis, two elements may be considered to be “like” if they provide a similar level of functionality (not capacity or utilization, but functionality—i.e. the RAID level, replication, etc.) or unlike if there are capabilities that the two elements do not share.

During a step 201, for a set of like elements determined during the step 200, one or more scenarios are generated or otherwise identified. In some embodiments, scenarios may be generated using a combinatorial algorithm or other process. For example, a group of like elements may include servers A, B, C and D. Thus, in a total server consolidation the scenario ABCD may represent or indicate that these elements can be combined into a single “integrated entity” running a single instance of the operating system with a single instance of the application in question while in a partial server consolidation the scenario ABCD may represent or indicate that these systems can be physically consolidated, but the unlike elements must be retained (e.g., two dissimilar applications).

In a storage consolidation, the elements A, B, C and D may represent storage requirements that share similar features. Identifying scenarios may include identifying every possible combination of the elements that has two or more elements. For example, the group of like elements ABCD can form the distinct combinations: AB, AC, AD, ABC, ABD, ACD, ABCD, BC, BD, BCD, and CD where the order of elements is not important (e.g., the group ABC is the same as the groups CBA, CAB, ACB, BCA and BAC). In some embodiments, a recursive function may be used to generate scenario combinations for a given set of like elements.

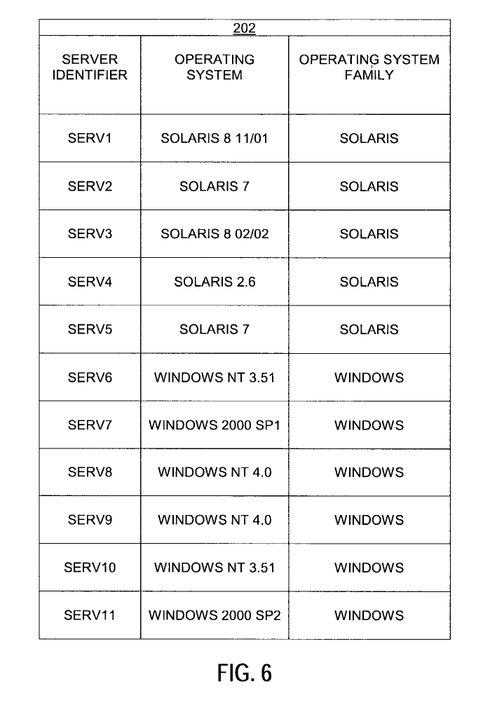

As one example of identifying scenarios in a total server consolidation, assume that eleven servers SERV1, SERV2, SERV3, SERV4, SERV5, SERV6, SERV7, SERV8, SERV9, SERV10, and SERV11 have the same or similar hardware configurations. In addition, each of the eleven servers has an operating system and belongs to an associated operating system family as illustrated in table 202 in FIG. 6. For purposes of this example, a like element may be defined as having the same operating system family as another element, but potentially different operating system “steppings”. For example, a server using the Solaris 7™ operating system and a server using the Solaris 8™ operating system would be close enough to be “like” but a machine using the Windows NT™ operating system would not. Thus, an operating system family is a collection of “like” typed operating systems that are upgradeable among themselves.

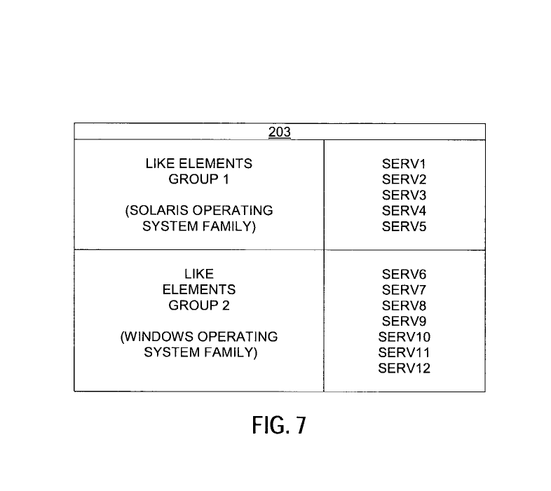

Now referring to FIG. 7, scenarios of like elements from the information in FIG. 6 can be established. As illustrated in table 203 FIG. 7, the servers SERV1, SERV2, SERV3, SERV4 and SERV5 comprise one set of like elements while the servers SERV6, SERV7, SERV8, SERV9, SERV10 and SERV11 comprise another set of like elements.

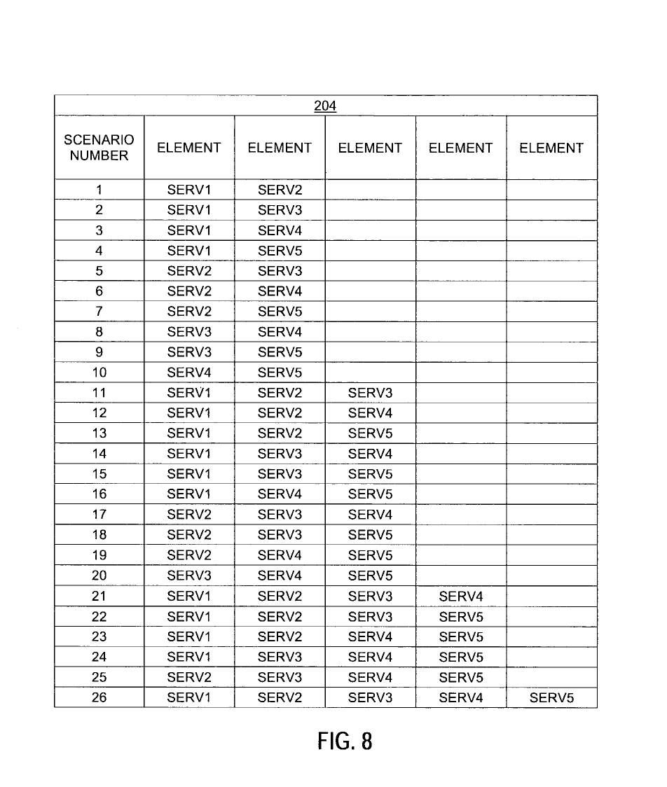

Once a group of like elements is identified, combinations of two or more different elements in the group can be created to generate scenarios. For example, now referring to FIG. 8, the twenty-six possible scenarios for the first group of like elements in table 204 of FIG. 7 (e.g., the Solaris™ operating system family) are illustrated. Scenario one includes the servers SERV1 and SERV2, scenario two includes the servers SERV1 and SERV3, etc.

During a step 205, the scenario determined during the step 201 is evaluated to determine if it is possible. In some embodiments, a resource, expert system or knowledge base (e.g., the resource 106) may be consulted, accessed or queried to identify or determine a possible scenario. For example, the resource 106 may store information regarding known incompatibilities and/or known compatibilities of like elements. As one example of an impossible scenario, two or more servers may include applications that may be incompatible and, as a result, cannot be operating or installed on the same server.

Assuming that a scenario determined during the step 201 is not considered possible, the method moves to a step 206 during which it is determined whether or not additional scenarios exist for the collection of like elements determined during the step 200. If another scenario exists, the method returns to the step 201. If no additional scenarios exist for the like elements determined during the step 200, the method may end or return back to the step 200 to determine another set of like elements for the inventory determined during the step 124.

In some embodiments, a process may be used to determine if a scenario is possible by attempting to create one or more potential configurations for the scenario. If a potential configuration for the scenario can be created, then the scenario is considered to be possible. If a configuration cannot be created for the scenario, the scenario is considered to not be possible.

For purposes of discussion of a potential example in a total server consolidation, scenario 19 from table 204 in FIG. 8 will be analyzed to determine if it is possible. Scenario 19 includes the servers identified as SERV2, SERV4 and SERV5. In order to construct a configuration for scenario 19, or to determine if a configuration is possible for the scenario 19, information regarding the processing, memory and storage I/O capabilities of the servers SERV2, SERV4 and SERV5 may be used. Such information may be determined as part of the inventory determined during the step 124.

For purposes of the present example, the server SERV2 is assumed to have four CPUs, each of which operates at 480 megahertz. The server SERV4 is assumed to have two CPUs, each of which operates at 500 megahertz. The server SERV5 is assumed to have four CPUs, each of which operates at 500 megahertz. In addition, the server SERV2 is assumed to have 2048 megabytes of memory, the server SERV4 is assumed to have 1024 megabytes of memory, and the SERV5 is assumed to have 1024 megabytes of memory. Furthermore, In addition, the server SERV2 is assumed to have 2048 megabytes of memory, the server SERV4 is assumed to have 1024 megabytes of memory, and the SERV5 is assumed to have 1024 megabytes of memory. In addition, each of the servers SERV2, SERV4, and SERV5 is assumed to have or need one hundred megabytes per second of bandwidth.

In some embodiments, in addition to the information above, each of the servers SERV2, SERV4, and SERV5 may have an associated CPU factor. A CPU factor may be used to equate performance among similar but not identical CPUs. For example, an Intel Pentium III™ processor has approximately fifty percent more processing capability than a similar speed Intel Pentium II™ processor. For purposes of the present example, the processors for the server SERV2 will be considered to be a Sun UltraSparc II™ processors which have a CPU factor of five and the processors for the servers SERV4 and SERV5 will be considered to be Sun UltraSparc II™ processors which have CPU factor of 7.5. In some embodiments, information regarding CPU factor for a processor or CPU may be stored in or retrieved from a database (e.g., the resource 106).

In order to determine the processing requirements for a potential configuration for the scenario that includes the servers SERV2, SERV4, and SERV5, a number of processing units required for each of the servers may be determined. A number of processing units required for each server can be determined by multiplying the server's number of processors times its CPU speed times its CPU factor. Thus, the processing requirement for the server SERV2 is 9,600 processing units (e.g., 9,600=4×480×5), the processing requirement for the server SERV4 is 7,500 processing units (e.g., 7,500=2×500×7.5), and the processing requirement for the server SERV5 is 15,000 processing units (e.g., 15,000=4×500×7.5). Thus, the total CPU processing requirements for a consolidation of the servers SERV2, SERV4, and SERV5 is 32,100 (e.g., 32,100=9,600+7,500+15,000). In some embodiments, the CPU processing requirement may be modified by permitting a specified level of utilization for CPU processing. For example, if SERV2 is only utilizing thirty percent of its total CPU processing capabilities, then only thirty percent of the total processing units are used in calculating the total. This ensures that the total processing units calculated are the number of units actually needed to accomplish the same level of work, and not the number of units that the original platform could theoretically produce. A user may be requested, queried, or prompted to provide utilization information for different servers or other pieces of equipment in order to generate scenarios and configurations. If the user does not provide such utilization information or such user information is not otherwise available, the utilization percentage for a server or other piece of equipment may be assumed to be at a designated level (e.g., one hundred percent).

In order to determine the memory requirement for a consolidation of the servers SERV2, SERV4, and SERV5, the memory requirements of the individual servers are totaled. Thus, the memory requirement for a consolidation of the servers SERV2, SERV4, and SERV5 is 4096 megabytes (e.g., 4096=2048+1024+1024).

In order to determine the storage I/O requirement for a consolidation of the servers SERV2, SERV4, and SERV5, the storage I/O requirements of the individual servers are totaled. Thus, the storage requirement for a consolidation of the servers SERV2, SERV4, and SERV5 is 300 megabytes per second of bandwidth (e.g., 300=100+100+100). In some embodiments, the storage I/O requirement may be modified by permitting a specified level of utilization for actual bandwidth required processing. For example, as was the case above, the actual bandwidth required for each platform is considered, not the total theoretical requirement. Therefore, the server SERV2 may have one hundred megabytes per second of theoretical bandwidth, but is actually only utilizing twenty percent of the bandwidth.

As determined by this example, the requirements for a consolidation of the servers SERV2, SERV4 and SERV5 are 32,100 units of processing, 4096 megabytes of memory, and 300 megabytes per second of bandwidth.

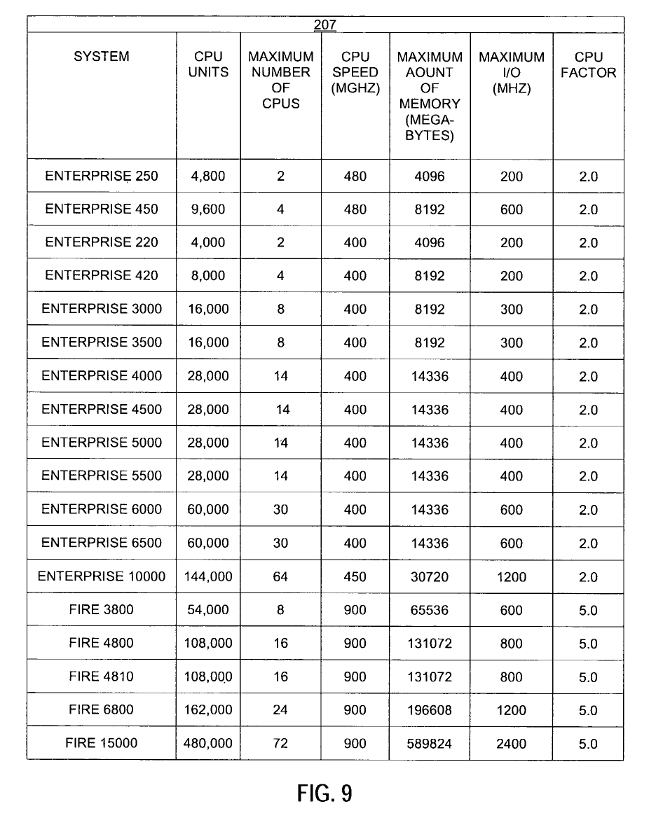

Once the requirements for the consolidated server are determined, the step 205 may include determining if a system is available that can support the requirements. Information regarding possible systems may be stored in a database (e.g., the resource 106). The step 205 may include querying the database regarding the requirements. For example, table 207 illustrated in FIG. 9 provides a representative list of systems that may be retrieved from the database or otherwise reviewed to determine if a system exists that can support the consolidation of the servers SERV2, SERV4 and SERV5. As illustrated by the entries in the table 207, only the system ENTERPRISE 3000 and below shown in the table 207 have adequate capabilities to meet the requirements. Thus, the potential configurations for a consolidation of the servers SERV2, SERV4 and SERV5 include the following systems: ENTERPRISE 3000, ENTERPRISE 3500, ENTERPRISE 4000, ENTERPRISE 4500, ENTERPRISE 5000, ENTERPRISE 5500, ENTERPRISE 6000, ENTERPRISE 6500, ENTERPRISE 10000, FIRE 3800, FIRE 4800, FIRE 4810, FIRE 6800, and FIRE 15000.

If the scenario selected or determined during the step 201 is possible (i.e., at least one potential configuration exists for the scenario), the step 126 moves to the step 208 where some or all of the possible configurations for the scenario selected during the step 201 may be determined. In some embodiments, the step 208 may use the results of the step 205. For example, the systems ENTERPRISE 3000, ENTERPRISE 3500, ENTERPRISE 4000, ENTERPRISE 4500, ENTERPRISE 5000, ENTERPRISE 5500, ENTERPRISE 6000, ENTERPRISE 6500, ENTERPRISE 10000, FIRE 3800, FIRE 4800, FIRE 4810, FIRE 6800, and FIRE 15000 are potential configurations for the scenario 19 discussed above. In some embodiments, a resource, expert system or knowledge base (e.g., the resource 106) may be consulted or queried to identify or determine possible configurations for a scenario.

During a step 210, a configuration determined during the step 208 is evaluated to determine if it is possible. An impossible configuration may include anything that cannot be constructed. For example, a server configuration may require too much memory, disk space, CPU processing capabilities, networking capabilities, or other requirements that cannot be put together. Thus, the configuration will be considered to be impossible. In some embodiments, a resource, expert system or knowledge base (e.g., the resource 106) may be consulted or queried to determine if a configuration is possible for a scenario.

In some embodiments, the step 210 may use or the results of the step 205. For example, the systems ENTERPRISE 3000, ENTERPRISE 3500, ENTERPRISE 4000, ENTERPRISE 4500, ENTERPRISE 5000, ENTERPRISE 5500, ENTERPRISE 6000, ENTERPRISE 6500, ENTERPRISE 10000, FIRE 3800, FIRE 4800, FIRE 4810, FIRE 6800, and FIRE 15000 are were determined to be potential (i.e., possible) configurations for the scenario 19 discussed above. Thus, another determination of possibility of one or more of these scenarios is not required for the step 210.

When determining if a configuration is possible for a partial server consolidation, additional or other factors may be taken into account. For example, the applications that are present on this platform must be capable of running on the same operating system instance. Thus, a configuration may not be possible in the partial server consolidation if one or more of the applications in question where incompatible with each other.

When determining if a configuration is possible for a box or system consolidation, additional or other factors may be taken into account. For example, the operating system versions in question must be compatible with the proposed hardware configuration target. Thus, a configuration may not be possible in the box of system consolidation if one or more of the operating system requirements were incompatible with the target hardware platform.

When determining if a configuration is possible for an IP telephony consolidation or upgrade, factors that may be taken into account include what calling features are required, the capacity of the calling environment, and the ability of the underlying network to support an IP telephony upgrade. Thus, a configuration may not be possible in the IP telephony consolidation or upgrade if one or more of these elements were not available.

When determining if a configuration is possible for a storage consolidation, factors that may be taken into account include the features and capabilities required by this environment. Thus, a configuration may not be possible in the storage consolidation if the features in question are not compatible with each other.

Assuming that a configuration determined during the step 208 is not considered possible, the method moves to a step 212 during which it is determined whether or not additional configurations exist for the scenario determined during the step 201. If another configuration exists, the method returns to the step 208. If no additional scenarios exist for the like elements determined during the step 200, the method may end or return back to the step 200 to determine another set of like elements for the inventory determined during the step 124.

Assuming that a configuration analyzed during the step 210 is possible, the method proceeds to a step 214 during which the configuration information determined during the step 208 is retained, stored in a database, or otherwise maintained.

In some embodiments, the step 205, 208, 210 or 214 may include determining one or more components in a configuration. For example, the number of processors in the final configuration, the amount of memory required, etc. In some embodiments, determining one or more components for a configuration may include accessing or querying a database or other resource that may include information regarding parts that may be compatible with each configuration. For example, if the proposed configuration needs 8000 megabytes of memory, then only those systems that support 8000 or more megabytes of information would be considered.

In some embodiments, components may be determined for a configuration as possible. First, take a minimum possible or base configuration. For example, a basic server may include some number of CPU's and an amount of memory as a standard configuration item (meaning that this selection is not optional).

Second, if the base configuration includes everything that is required for a given scenario, than no further action is needed. Third, if the base configuration does not include everything that is required for a given scenario, find the “building block” components for an unmet requirement that are compatible for the configuration and determine the “largest” and “smallest” of this components in regards to the unmet requirement. For example, if the requirement is for 4000 megabytes of additional memory, and the available “building blocks” are 512 megabytes, 1000 megabytes, and 2000 megabytes, then the smallest building block is 512 megabytes and the largest is 2000 megabytes.

Fourth, if the smallest building block is larger than the requirement (i.e., it satisfies the requirement), the smallest building block is used in the configuration and no further action is needed to satisfy this requirement. A return to the third step might occur if other unmet requirements exist for the base configuration.

Fifth, if the largest building block is smaller than the requirement (i.e., it does not satisfy the requirement), then take the requirement and divide it by the “size” of the largest building block to determine the required number of building blocks. For example, if the requirement is for 4000 megabytes of memory and the largest “building block” is 2000 megabytes, then a quantity of two 2000 megabyte “blocks” are required. No further action is needed to satisfy this requirement. A return to the third step might occur if other unmet requirements exist for the base configuration.

Sixth, if the smallest building block is smaller than the requirement and the largest building block is larger than the requirement, than take the smallest increment of the smallest building block that will satisfy the requirement or the smallest building block other than the smallest building block that will satisfy the requirement. For example, if a requirement exists for 1500 megabytes of memory and the available options are 500, 1000, 2000 and 4000 megabytes, then the decision would be to take the 2000 megabyte size (that is the smallest requirement that will fulfill our need). A return to the third step might occur if other unmet requirements exist for the base configuration.

Seventh, return to step three if other unmet requirements exist for the configuration. As one example of complete identification of components for one or more servers, this configuration may have required 8000 megabytes of memory and 4 CPU's. Therefore, the requirement may be met using a base package that contains 2 CPU's and 2000 megabytes of memory, with the addition of a 4000 megabyte memory block, a 2000 megabyte memory block, and additional CPU blocks.

Once components have been identified for a given configuration, the component and configuration information may be stored or maintained during the step 214. During a step 216, financial information may be determined for the scenario determined during the step 201 as may be represented by the configuration determined for the scenario determined during the step 208. In some embodiments, the step 216 may include accessing or otherwise obtaining costs associated with different elements in a configuration. Such costs may be stored in a resource or database and/or obtained from vendors, suppliers, etc.

Financial models for a configuration may take any number of factors into account such as, for example, initial purchase/lease initiation date of the hardware or devices in question; lease payments/depreciation costs for the hardware or devices in question; support and maintenance costs for the hardware or devices in question; license purchase costs/lease initiation date for the software in question; software license maintenance/support costs for the software in question; period of time to depreciate an investment/pay for a lease of hardware/software in question; etc. Different cost models may be developed for a scenario depending on whether equipment will be leased or purchased, one time fees or on-going fees are used, etc. Thus, each configuration may result in different financial models. In some embodiments, the methods of the present invention may try to determine or model one or more of the lowest costs for a configuration. A user may provide information regarding whether or not the user is willing to, wants to, or required to purchase or lease equipment, whether or not the user is willing to, wants to, or required to use one-time fees versus periodic fees, etc. Thus, user preferences or requirements may dictate how some of the costs for a configuration are determined.

In some embodiments, other financial models or analysis may be conducted for a configuration. For example, an analysis may be conducted for a configuration wherein a replacement date for hardware and/or software in the configuration is determined or taken into account. The replacement date may be the point in time at which the current hardware and software will no longer meet required capabilities (e.g., a designated number of users or transactions). The replacement date may then be used to take into the account the price or cost of a new configuration.

As one example of a use of a replacement date for conducting a financial analysis of a configuration, assume that hardware for a configuration was purchased on Jan. 1, 2001, and that the hardware will no longer be adequate as of July 2003. Therefore, in order to determine the “loaded cost” of the configuration as part of the step 216, the analysis takes the configuration in question and “extends it” hypothetically to what it would really cost. This extended cost may be computed by taking the current hardware platform and its capabilities, dividing that by the number of users and then projecting that forward to the end of the reporting window (typically three years). At that date, the amount of“increase” required is computed based on the purchase price. This increase is then added to the purchase price for the “refresh” cost of the configuration. This refresh cost represents a hypothetical cost of upgrading the current environment to meet the new needs. This refresh cost is then entered into the model as a new cost element on the old configuration (the new configuration is just expanded to accommodate the required elements). In addition, the lost depreciation and the disposal cost are deducted.

In some embodiments, the step 126 or the method 120 may include determining a replacement date for a configuration or scenario.

In some embodiments, a return on investment (ROI) may be determined during the step 216 regarding a configuration determined during the step 208. The ROI takes into account the costs of the current configuration and the costs of the new configuration. The costs of the current configuration may be determined during the inventory process. For example, the current configuration cost would include the hardware purchase price (if it were purchased outright), the monthly hardware support costs, the acquisition costs of any software that may be installed and its monthly maintenance costs, as well as lease payments, end-of-lease acquisition costs, and disposal fees, etc. The costs of the new configuration may be generated using the component determined for a configuration. For example, the new costs would include the hardware price of the new configuration, its maintenance costs, the acquisition costs for any software, etc. A comparison between the two costs indicates the ROI of the new configuration.

In some embodiments, information regarding the costs associated with hardware and software elements may be stored in or accessed from a knowledgebase, database or other resource (e.g., the resource 106).

Once costs for one or more configurations are determined, the costs may be broken down into a worksheet format based on particular time elements. For example, if a configuration includes a lease, maintenance, license, termination, buy-out, or other payment that must be paid periodically (e.g., monthly, quarterly, yearly), the costs may be added for the appropriate month. As another example, if equipment is being purchased outright as part of a new configuration, depreciation costs may be added in for the appropriate times in the worksheet. As a third example, if equipment in the current configuration has a disposal cost, the cost may be added at the appropriate time in the worksheet.

In addition to costs discussed above for a configuration, in some embodiments an “upgrade” cost also might be associated with the configuration. The upgrade cost for a configuration is the anticipated weighted cost required to upgrade various software components in the configuration to the most recent revisions, version levels, etc. Upgrade costs may take into account the upgrading of operating systems, the upgrading of applications, etc. The computation of upgrade costs may be particular useful when conducting a server consolidation since numerous operating systems and/or applications may need to be taken into account. Computation of upgrade costs may be less significant or unneeded in an IP telephony upgrade or a storage consolidation.

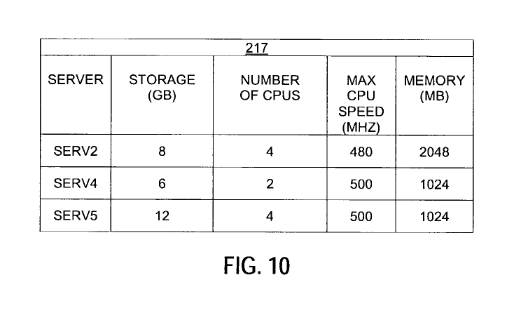

One method of determining an upgrade cost for a configuration can be computed as follows. First, a system magnitude is determined, which is indicative of the amount of effort (and risk) involved in upgrading a particular configuration to the new configuration. A system magnitude for a server in a scenario for a total server consolidation can be computed as follows: magnitude=[(number of CPU's for the server)/4)×(amount of memory in megabytes (MB)/128)×(amount of used storage in megabytes (MB)/16)]/1000. For the example discussed above regarding scenario 19 in table 204 of FIG. 8, suppose the servers SERV2, SERV4 and SERV5 have the components as determined during the inventory conducted during the step 124 and illustrated in FIG. 10. As a result, the server SERV2 has a magnitude of eight, the server SERV4 has a magnitude of three, and the server SERV5 has a magnitude of eight.

Second, a system weight is determined, which is indicative of the amount of work needed to migrate or upgrade a particular configuration. In some embodiments, the system weight for a system may be a number between zero and one hundred that identifies the relative difficulty of accomplishing the upgrade, with zero indicating that no upgrade difficulty and one hundred indicating that an upgrade is impossible. For example, a configuration may require upgrading of an operating system. In another example, a configuration may require upgrading of an operating system and an application.

In some embodiments, information regarding weights of upgrades may be stored in a database or other resource and received as necessary. In some embodiments, the weights may be determined relative to each other over time. In other embodiments, a weight for an upgrade in a total server consolidation may be calculated as shown in the following example. Continuing the example as stated above (using the servers SERV2, SERV4 and SERV5), the weight may be determined or calculated from lookups in the knowledgebase. For example, if the server SERV2 is running the Solaris 7™ operating system, the server SERV4 is running the Solaris 8™ operating system, and the server SERV5 is running the Solaris 8™ operating system, then the new system configuration will be running the Solaris 8™ operating system since it is the latest release of the operating system. Therefore, in order to build the new environment, the server SERV2 will have to be updated. By looking in the knowledgebase, the weight of a Solaris 7™ operating system upgrade is eight. Second, in this scenario, the servers SERV2, SERV4, and SERV5 are all running versions of Oracle™ database software (for this example, we will assume the Oracle™ 7.3.4 database software for the server SERV2 and the Oracle™ 8.1.7 database software for the servers SERV4 and SERV5). Therefore, this environment will use Oracle™ 8.1.7 database software as the new configuration. To accomplish this, the server SERV2 must be upgraded. Looking in the knowledgebase, an upgrade of the Oracle™ 7.3.4 database software to the Oracle™ 8.1.7 database software may have a weight of thirty-one. Now that the individual elements are calculated, the final requirement is to calculate the final weight. This is calculated by generating the mean of all the systems that must be upgraded. Systems that do not need to be upgraded, in this example the servers SERV4 and SERV5, are not included in the average. In this example, the weight would be the average of eight for the Solaris™ operating system upgrade and thirty-one for the Oracle™ database software upgrade, divided by the number of systems (in this case, one), for a final weight of thirty-nine.

Third, the system magnitudes and the system weights are used to create an overall difficulty weight by summing the products of each server's magnitude and weight for the configuration. For example, if the servers SERV2, SERV4 and SERV5 each are assumed to have a weight of ten, the overall difficulty weight for the new configuration that consolidates the servers SERV2, SERV4 and SERV5 is as follows: (8×10)+(3×10)+(8×10)=190. In this example, only the operating system is being upgraded so only a single weight is involved. In a different consolidation, where upgrading of an application may be involved, the total weight would include a portion indicative of the upgrading of the operating system and a portion indicative of the upgrading of the application.

Fourth, the upgrade cost for the configuration can be determined by multiplying the difficulty weight for the configuration by a loaded cost parameter that can convert the numerical difficulty weight into an associated cost. For example, the cost parameter for the consolidation of servers SERV2, SERV4 and SERV5 may be ten dollars. Thus, the overall upgrade cost for the consolidation is $1,900 (e.g., $10×190). Different cost parameters may be used for different types of consolidations or different embodiments.

[Magnitude and weight are only used for a server consolidation] [Jeff, lets discuss this]

During a step 218, the financial information computed or otherwise determined during the step 216 is retained, stored in a database, or otherwise maintained for later use of analysis.

During a step 220, a determination if made to see if other configurations exist for the scenario determined during the step 201. If at least one other configuration exists, the method determines another configuration during a step 222 and then returns to the step 210.

If other configurations do not exist, the method proceeds to a step 224 during which a determination is made to see if other scenarios exist for the group of like elements determined during the step 200. If at least one other scenario exists, the method determines another scenario during a step 226 and then returns to the step 205. If other scenarios do not exist, the method may proceed to the step 200 where another set of like elements may be determined for an inventory. The process than begins again for the new set of like elements.

Eventually, the step 126 may include determining all sets of like elements for a given inventory, determining all scenarios for each of the sets of like elements, and determining all configurations for each of the scenarios. The step 126 may then stop or otherwise end. As part of the step 126, a financial analysis may be made of each configuration or scenario. In some embodiments, such a financial analysis may be made when each configuration or scenario is determined. In other embodiments, the financial analysis may be conducted after some or all of the possible configurations or scenarios have been determined.

After the step 126 is completed, one or more reports regarding the financial analysis of one or more potential configurations/scenarios may be generated and/or provided during the step 128. For example, a report might indicate ROI or other information determined for one or more configurations, the upgrade costs for one or more configurations, the detailed information (e.g., components, operating system) involved in one or more configurations, the timing of certain costs associated with a configuration (e.g., monthly or annual maintenance fees, license renewal fees, license upgrade fees, etc.), etc. In some embodiments, results of the analysis conducted during the step 126 may be provided via a Web site or interface, emailed or otherwise transmitted to one or more parties or devices, stored in a database, etc. As another example, a Web site or interface may allow a user to select or view one or more reports resulting from an analysis of an inventory.

In some embodiments, the method 120 may include making recommendations or prioritizing financial information or other information provided in a report. For example, a user analyzing an inventory as part of a consolidation might only consider configurations that meet or exceed a threshold ROI, that use equipment from designated vendors, or that meet some other criteria established or used by the user. As another example, a report might sort configurations by lowest upgrade cost, highest ROI, or some other factor designated or selected by a user.

Server

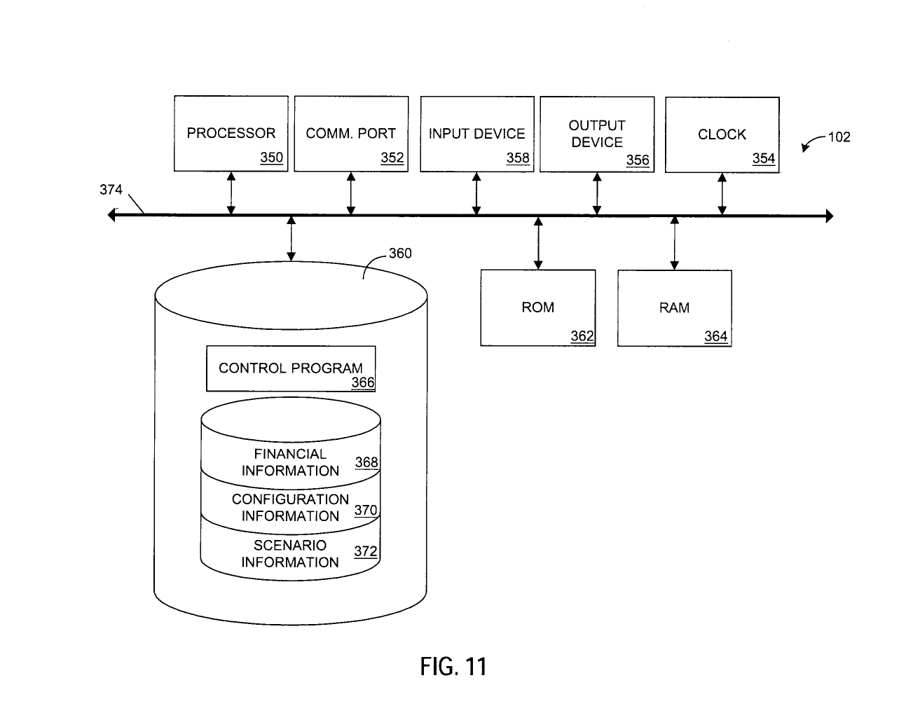

Now referring to FIG. 11, a representative block diagram of a server or controller 102 is illustrated. As previously discussed above, in some embodiments the server 102 may provide or host a Web site or other interface that allows a user to select or indicate an analysis to be conducted, provide inventory information, select or view reports or other results regarding an analysis of an inventory, etc.

The server 102 may include a processor, microchip, central processing unit, or computer 350 that is in communication with or otherwise uses or includes one or more communication ports 352 for communicating with user devices and/or other devices. Communication ports may include such things as local area network adapters, wireless communication devices, Bluetooth technology, etc. The server 102 also may include an internal clock element 354 to maintain an accurate time and date for the server 102, create time stamps for communications received or sent by the server 102, etc.

If desired, the server 102 may include one or more output devices 356 such as a printer, infrared or other transmitter, antenna, audio speaker, display screen or monitor, text to speech converter, etc., as well as one or more input devices 358 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the server 102 may include a memory or data storage device 360 to store information, software, databases, communications, device drivers, financial models and analysis formulas, component compatibility information, configuration or scenario generation algorithms, risk or weight scoring algorithms, etc. The memory or data storage device 360 preferably comprises an appropriate combination of magnetic, optical and/or semiconductor memory, and may include, for example, Random Read-Only Memory (ROM), Random Access Memory (RAM), a tape drive, flash memory, a floppy disk drive, a Zip™ disk drive, a compact disc and/or a hard disk. The server 102 also may include separate ROM 362 and RAM 364.

The processor 350 and the data storage device 360 in the server 102 each may be, for example: (i) located entirely within a single computer or other computing device; or (ii) connected to each other by a remote communication medium, such as a serial port cable, telephone line or radio frequency transceiver. In one embodiment, the server 102 may comprise one or more computers that are connected to a remote server computer for maintaining databases.

A conventional personal computer or workstation with sufficient memory and processing capability may be used as the server 102. In one embodiment, the server 102 operates as or includes a Web server for an Internet environment. The server 102 preferably is capable of high volume transaction processing, performing a significant number of mathematical calculations in processing communications and database searches. A Pentium™ microprocessor such as the Pentium III™ or IV™ microprocessor, manufactured by Intel Corporation may be used for the processor 350. Other or equivalent processors are available from Motorola, Inc., AMD, or Sun Microsystems, Inc. The processor 350 also may comprise one or more microprocessors, computers, computer systems, etc.

Software may be resident and operating or operational on the server 102. The software may be stored on the data storage device 360 and may include a control program 366 for operating the server, databases, etc. The control program 366 may control the processor 350. The processor 350 preferably performs instructions of the control program 366, and thereby operates in accordance with the present invention, and particularly in accordance with the methods described in detail herein. The control program 366 may be stored in a compressed, uncompiled and/or encrypted format. The control program 366 furthermore includes program elements that may be necessary, such as an operating system, a database management system and device drivers for allowing the processor 350 to interface with peripheral devices, databases, etc. Appropriate program elements are known to those skilled in the art, and need not be described in detail herein.

The server 102 also may include or store information regarding users, user devices, content segments, configurations, scenarios, elements, reports, communications, etc. For example, information regarding one or more financial models may be stored in a financial information database 368 for use by the server 102 or another device or entity. Information regarding one or more configurations may be stored in a configuration information database 370 for use by the server 102 or another device or entity and information regarding one or more scenarios may be stored in a scenario information database 372 for use by the server 102 or another device or entity. In some embodiments, some or all of one or more of the databases may be stored or mirrored remotely from the server 102.

According to an embodiment of the present invention, the instructions of the control program may be read into a main memory from another computer-readable medium, such as from the ROM 362 to the RAM 364. Execution of sequences of the instructions in the control program causes the processor 350 to perform the process steps described herein. In alternative embodiments, hard-wired circuitry may be used in place of, or in combination with, software instructions for implementation of some or all of the methods of the present invention. Thus, embodiments of the present invention are not limited to any specific combination of hardware and software.

The processor 350, communication port 352, clock 354, output device 356, input device 358, data storage device 360, ROM 362, and RAM 364 may communicate or be connected directly or indirectly in a variety of ways. For example, the processor 350, communication port 352, clock 354, output device 356, input device 358, data storage device 360, ROM 362, and RAM 364 may be connected via a bus 374.

While specific implementations and hardware configurations for the server 102 have been illustrated, it should be noted that other implementations and hardware configurations are possible and that no specific implementation or hardware configuration is needed. Thus, not all of the components illustrated in FIG. 11 may be needed for a server implementing the methods disclosed herein. Therefore, many different types of implementations or hardware configurations can be used in the system 100 and the methods disclosed herein are not limited to any specific hardware configuration.

User Device

As mentioned above, user device 108 may be or include any of a number of different types of devices, including, but not limited to a personal computer, portable computer, mobile or fixed user station, workstation, network terminal or server, telephone, beeper, kiosk, dumb terminal, personal digital assistant, facsimile machine, two-way pager, radio, cable set-top box, etc. In some embodiments, a user device 108 may have the same structure or configuration as the server 102 illustrated in FIG. 1 and include some or all of the components of the server 102.

Interfaces

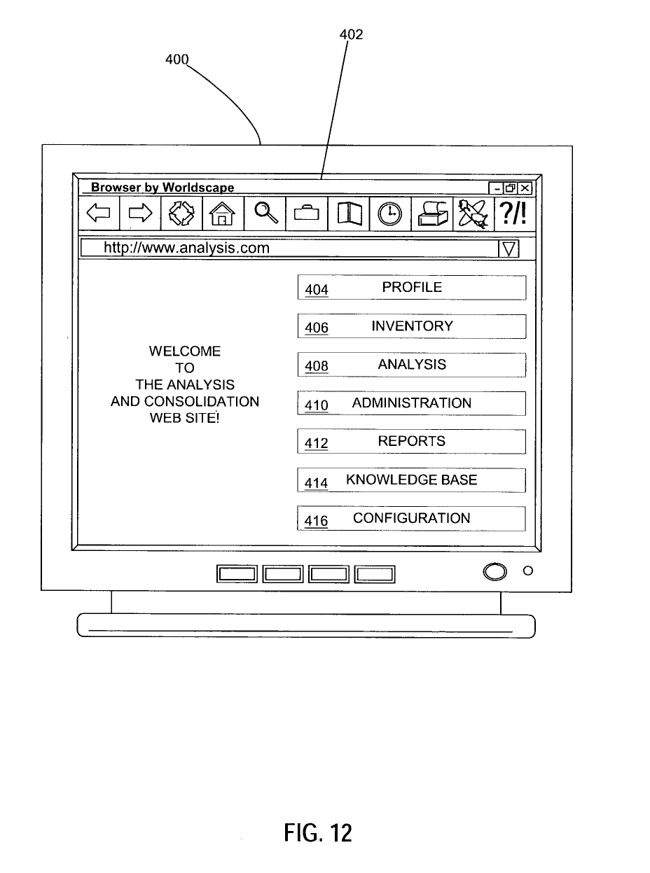

In some embodiments, one or more interfaces may be used to implement one or more steps of the methods described herein or during implementation of one or more of the steps and/methods described here. Many different types of interfaces may be used and the methods and steps described herein are not limited to any specific implementation or embodiment of an interface. For example, now referring to FIG. 12, a monitor or display 400 that may be part of a user device (e.g., the user device 108), a server (e.g., the server 102), or other device may display a window 402 having an interface. The window 402 may be displayed by browser or other software operating on a device. The window 402 may be created as part of a Web site. For purposes of explanation, but not limitation, the window 402 is assumed to be implemented by the server 102 as part of a Web site.

The window 402 may include a number of selectable or clickable buttons 404, 406, 408, 410, 412, 414, and 416 that allow a user of the window 402 to implement different features or conduct different actions. For example, selecting the “PROFILE” button 402 may cause display of or lead to another interface, window, or Web page that allows the user to register, select or obtain a password or login, or provide other information to the server 102 (e.g., company information, address information, contact information, etc.). Selecting the “INVENTORY” button 406 may cause display of or lead to another interface, window, or Web page that allows the user to provide information regarding inventory of elements. Such inventory information may be received by the server 102 as part of the step 124. Selecting the “ANALYSIS” button 408 may cause display of or lead to another interface, window, or Web page that allows a user to select or indicate a type of analysis to be conducted. Such analysis information may be received or used by the server during the step 122. Selecting the “ADMINISTRATION” button 410 may allow cause display of or lead to another interface, window, or Web page that allows a user to conduct administrative functions such as adding and deleting other uses, modifying one or more windows, links or interfaces, etc. Selecting the “REPORTS” button 412 may cause display of or lead to another window, interface, or Web page that allows a user to obtain one or more reports created as part of an analysis. Selecting the “KNOWLEDGE BASE” button 414 may allow a user to enter, delete or modify information in a database regarding potential hardware and software elements. Selecting the “CONFIGURATION” button 416 may cause display of or lead to another window, interface, or Web page that allows a user to enter information regarding hardware and/or software components. For example, if information for a particular device or application is not included in the knowledge base or other resource, a user may be able to provide specification and operational information regarding the device or application. The information may be used as part of the knowledge base for the analyzing a configuration or inventory that includes the device or application. In addition, the information may be used for other users or other configurations or inventories (although confirmation of such information or approval to add such information permanently to the knowledge base or other database may be needed). Other embodiments may contain additional or different sets and/or arrangements of buttons and other features.

In some embodiments, different users may have different privileges that allow access to or use of different sets of buttons or features in the window 402. For example, some users may be able to select or use all of the buttons 404, 406, 408, 410, 412, 414, and 416. Other users may only be able to select or use the buttons 404, 406, 408, 412, and 416. The access and use of different buttons may be established or monitored by an administrator who accesses features that control user options via the “ADMINISTRATION” button 410.

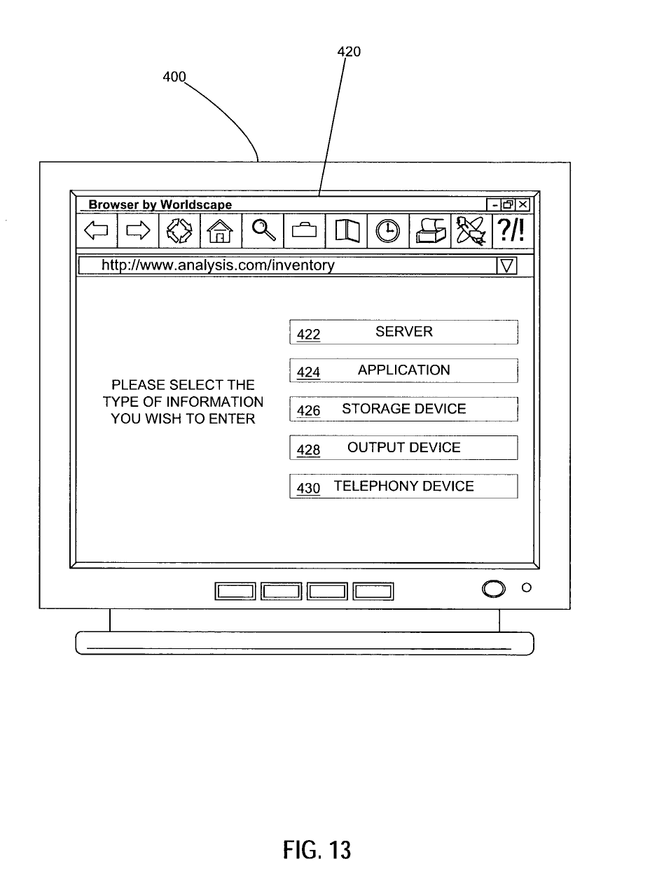

As previously discussed above, selecting the “INVENTORY” button 406 in the window 402 may cause display of another window, such as the window 420 illustrated in FIG. 13. The window 420 may allow a user to select the type of information the user wants to enter or the type of element the user wants to information about. For example, the window 420 may include buttons 422, 424, 426, 428, and 430. Selecting the “SERVER” button 422 may cause display of or lead to another window, interface, or Web page that allows the user to enter information regarding one or more servers. Selecting the “APPLICATION” button 424 may cause display of or lead to another window, interface, or Web page that allows the user to enter information regarding one or more applications. Selecting the “STORAGE DEVICE” button 426 may cause display of or lead to another window, interface, or Web page that allows the user to enter information regarding one or more storage devices. Selecting the “OUTPUT DEVICE” button 428 may cause display of or lead to another window, interface, or Web page that allows the user to enter information regarding one or more output devices. Selecting the “TELEPHONY” button 430 may cause display of or lead to another window, interface, or Web page that allows the user to enter information regarding one or more telephony devices.

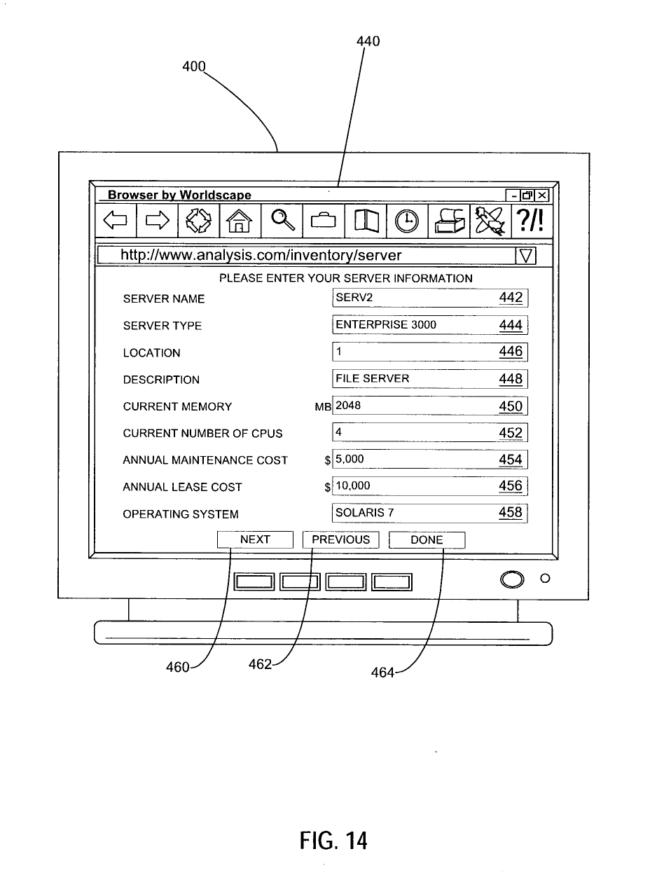

Now referring to FIG. 14, selecting the “SERVER” button 422 on the window 420 may cause display of a window 440 that allows a user to enter information regarding a server by entering appropriate information into the text boxes 442, 444, 446, 448, 450, 452, 454, 456, and 458. The user may continue to enter information (e.g., bandwidth information, utilization information) regarding the server on a new window by selecting “NEXT” button 460. The user may return to the previous window 420 by selecting “PREVIOUS” button 462. The user may indicate that the user is done entering information for a particular server by selecting “DONE” button 464. Selecting the “DONE” button 464 may return the user to window 420. In some embodiments, if a user does not provide information for a particular text block in the window 440, the user may be queried or prompted to provide the necessary information. Alternatively, information for the text block may be assumed. For example, a server may be assumed to have the minimal amount of memory that comes with the base model of the server. In some embodiments, servers may be leased or purchased/owned. Thus, many different costs may be associated with a particular server.

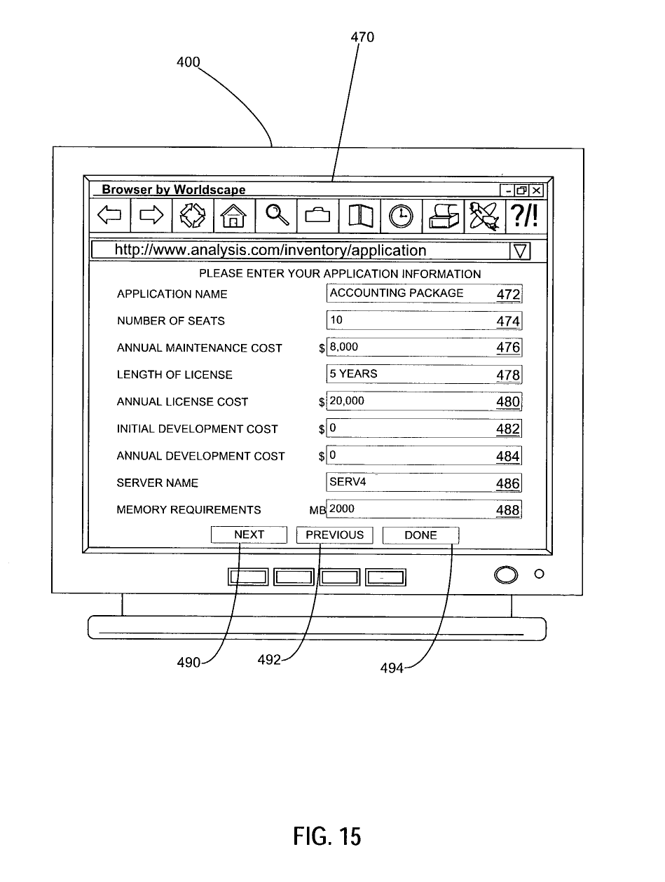

Now referring to FIG. 15, selecting the “APPLICATION” button 424 on the window 420 may cause display of a window 470 that allows a user to enter information regarding an application by entering appropriate information into the text boxes 472, 474, 476, 478, 480, 482, 484, 486, and 488. The user may continue to enter information regarding the application on a new window by selecting “NEXT” button 490. The user may return to the previous window 420 by selecting “PREVIOUS” button 492. The user may indicate that the user is done entering information for a particular application by selecting “DONE” button 494. Selecting the “DONE” button 494 may return the user to window 420. In some embodiments, if a user does not provide information for a particular text block in the window 470, the user may be queried or prompted to provide the necessary information. Alternatively, information for the text block may be assumed. In some embodiments, applications may be licensed or developed in-house. Thus, many different costs may be associated with a particular application.

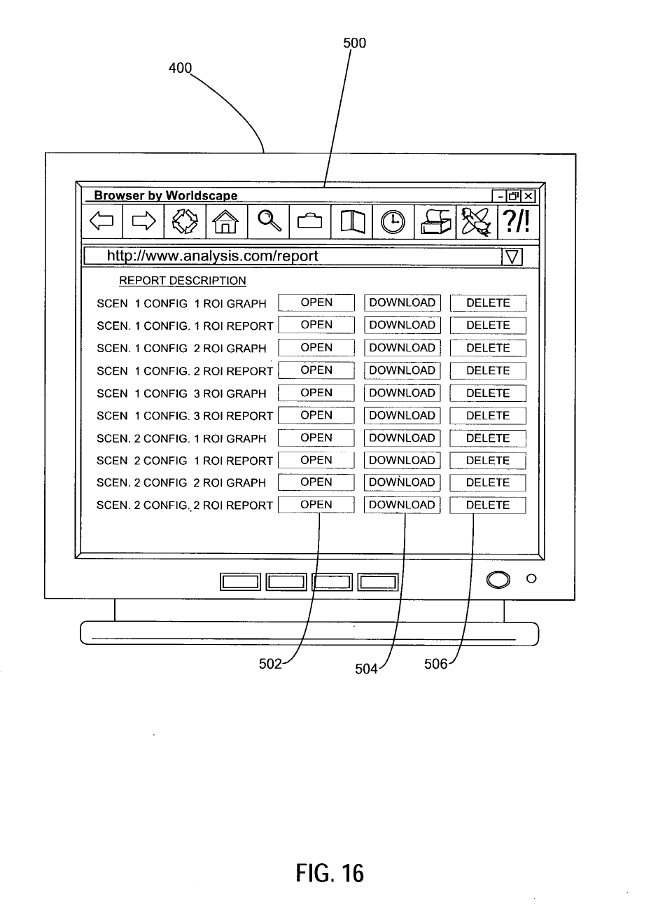

As previously discussed above, selecting the “REPORTS” button 412 in the window 402 may cause display of another window, such as the window 500 illustrated in FIG. 16. The window 500 may allow a user to obtain, view, download, open, delete, etc. one or more reports or other information regarding one or more analyzed configurations or scenarios. For example, as illustrated in FIG. 16, the window 500 allows information for three different configurations in scenario 1 and two different configurations in scenario 2 to be opened downloaded or deleted. More specifically, selecting “OPEN” button 502 will cause a report for configuration 2 of scenario 2 to be opened. Selecting “DOWNLOAD” button 504 will cause the report for configuration 2 of scenario 2 to be downloaded. Selecting “DELETE” button 506 will cause the report for configuration 2 of scenario 2 to be deleted.

The methods of the present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

Each of the methods described above can be performed on a single computer, computer system, microprocessor, etc. In addition, two or more of the steps in each of the methods described above could be performed on two or more different computers, computer systems, microprocessors, etc., some or all of which may be locally or remotely configured. The methods can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Although the present invention has been described with respect to various embodiments thereof, those skilled in the art will note that various substitutions may be made to those embodiments described herein without departing from the spirit and scope of the present invention.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

The embodiments of the invention in which an exclusive property or privilege is claimed are defined as follows:

1. A method for facilitating consolation of an inventory of elements, comprising:
determining a plurality of sets of like elements from an inventory of elements;
determining, for at least one of said plurality of sets of like elements, a plurality of potential scenarios, wherein each of said plurality of potential scenarios includes at least two of said like elements;
determining, for at least one of said plurality of potential scenarios, a plurality of potential configurations, wherein each of said plurality of potential configurations represents a consolidation of at least two of said like elements; and
providing information regarding at least one of said plurality of potential configurations.

2. The method of claim 1, wherein said determining a plurality of sets of like elements from an inventory of elements includes determining all sets of like elements from said inventory of elements.

3. The method of claim 1, wherein said determining, for at least one of said plurality of sets of like elements, a plurality of potential scenarios includes determining all possible scenarios for said at least one of said plurality of sets of like elements.

4. The method of claim 1, wherein said determining, for at least one of said plurality of potential scenarios, a plurality of potential configurations includes determining all possible configurations for a possible scenario from said plurality of potential scenarios.

5. The method of claim 1, wherein said providing information regarding at least one of said plurality of potential configurations includes providing information regarding all of said plurality of potential configurations.

6. The method of claim 1, further comprising:
conducting a financial analysis of at least one of said plurality of potential configurations.

7. The method of claim 6, wherein said conducting a financial analysis of at least one of said plurality of potential configurations includes determining an upgrade cost for said at least one of said plurality of potential configurations.

8. The method of claim 7, wherein said upgrade cost includes a system magnitude component and a weight component.

9. The method of claim 1, further comprising:
selecting at a least one of said plurality of potential configurations based on at least one designated criterion.

10. The method of claim 9, wherein said selecting at a least one of said plurality of potential configurations based on at least one designated criterion includes providing a report sorting at least two of said plurality of potential configurations according to said at least one designated criterion.

11. The method of claim 9, further comprising:
determining said at least one designated criterion.

12. The method of claim 1, further comprising:
determining said inventory of elements.

13. The method of claim 12, wherein said determining said inventory of elements includes receiving information regarding said inventory of elements from a user.

14. The method of claim 1, further comprising:
selecting said at least one of said plurality of potential scenarios.

15. The method of claim 1, further comprising:
selecting said at least one of said plurality of potential configurations.

16. The method of claim 1, further comprising:
evaluating whether said at least one of said plurality of potential scenarios is possible.

17. The method of claim 1, further comprising:
evaluating whether said at least one of said plurality of potential configurations is possible.

18. The method of claim 1, further comprising:
selecting said at least one of said plurality of sets of like elements.

19. The method of claim 1, wherein said determining a plurality of sets of like elements from an inventory of elements includes determining all possible sets of like elements from said inventory of like elements.

20. The method of claim 19, wherein said determining, for at least one of said sets of like elements, a plurality of potential scenarios includes determining all possible scenarios for said all possible sets of like elements from said inventory of like elements.

21. The method of claim 20, wherein said determining, for at least one of said plurality of potential scenarios, a plurality of potential configurations scenarios includes determining all possible configurations for said all possible scenarios.

22. The method of claim 1, wherein said determining, for at least one of said plurality of sets of like elements, a plurality of potential scenarios includes determining a plurality of potential scenarios for each of said plurality of sets of like elements.

23. The method of claim 1, wherein said determining, for at least one of said plurality of potential scenarios, a plurality of potential configurations includes determining a plurality of potential configurations for each of said plurality of potential scenarios.

24. The method of claim 1, further comprising:
determining a replacement date for at least one of said plurality of like elements.

25. The method of claim 1, further comprising:
providing an interface that allows a user to provide information regarding at least one element.

26. The method of claim 1, further comprising:
providing an interface that allows a user to obtain said information regarding at least one of said plurality of potential configurations.

27. A method for facilitating analysis of an inventory of elements for consolidation, comprising:
determining an inventory of elements;
determining a plurality of sets of like elements from said inventory of elements;
determining, for at least one of said plurality of sets of like elements, a plurality of potential scenarios, wherein each of said plurality of potential scenarios includes at least to of said like elements;
determining, for at least one of said plurality of potential scenarios, a plurality of potential configurations, wherein each of said plurality of potential configurations represents a consolidation of at least two of said like elements; and
conducting a financial analysis of at least one of said plurality of potential configurations.

28. The method of claim 27, further comprising:
providing financial information regarding at least one of said plurality of potential configurations.

29. A method for facilitating analysis of an inventory of elements for consolidation, comprising:
determining an inventory of elements;
determining a plurality of sets of like elements from said inventory of elements;
determining, for each of said set of like elements in said plurality of sets of like elements, a plurality of potential scenarios, wherein each of said plurality of potential scenarios includes at least to of said like elements;
determining, for each scenario in said plurality of potential scenarios, a plurality of potential configurations, wherein each of said plurality of potential configurations represents a consolidation of at least two of said like elements; and
conducting a financial analysis of each of said plurality of potential configurations.

30. The method of claim 29, further comprising:
providing financial information regarding at least one of said plurality of potential configurations.

31. A system for facilitating analysis of an inventory of elements for consolidation, comprising:
a memory;
a communication port; and
a processor connected to said memory and said communication port, said processor being operative to:
determine a plurality of sets of like elements from an inventory of elements;
determine, for at least one of said plurality of sets of like elements, a plurality of potential scenarios, wherein each of said plurality of potential scenarios includes at least two of said like elements;
determine, for at least one of said plurality of potential scenarios, a plurality of potential configurations, wherein each of said plurality of potential configurations represents a consolidation of at least two of said like elements; and
provide information regarding at least one of said plurality of potential configurations.

32. A computer program product in a computer readable medium for consolidation, comprising:
first instructions for identifying a plurality of sets of like elements from an inventory of elements;
second instructions for identifying, for at least one of said plurality of sets of like elements, a plurality of potential scenarios, wherein each of said plurality of potential scenarios includes at least two of said like elements;
third instructions for identifying, for at least one of said plurality of potential scenarios, a plurality of potential configurations, wherein each of said plurality of potential configurations represents a consolidation of at least two of said like elements; and
fourth instructions for sending information regarding at least one of said plurality of potential configurations.
